(19) United States
(12) Patent Application Publication
(10) Pub. No.: US 2003/0169353 A1
(43) Pub. Date: Sep. 11, 2003

(54) Method and apparatus for processing sensor images

(76) Inventors: Renato Keshet, Haifa (IL); Ron P. Maurer, Haifa (IL); Doron Shaked, Haifa (IL); Yacov Hel-Or, Zichron Yacov (IL); Danny Barash, New York, NY (US)

Correspondence Address: HEWLETT-PACKARD COMPANY, Intellectual Property Administration, P.O. Box 272400, Fort Collins, CO, 80527-2400, US

(21) Appl. No.: 10/096,025

(22) Filed: Mar. 11, 2002

(51) Int. Cl. H04N 5/335

(52) U.S. Cl. 348/272

(57) ABSTRACT

A sensor image is processed by applying a first demosaicing kernel to produce a sharp image; applying a second demosaicing kernel to produce a smooth image; and using the sharp and smooth images to produce an output image.

### BACKGROUND

Digital cameras include sensor arrays for generating sensor images. Certain digital cameras utilize a single array of non-overlaying sensors in a single layer, with each sensor detecting only a single color. Thus only a single color is detected at each pixel of a sensor image.

A demosaicing operation may be performed on such a sensor image to provide full color information (such as red, green and blue color information) at each pixel. The demosaicing operation usually involves estimating missing color information at each pixel.

The demosaicing operation can produce artifacts such as color fringes in the sensor image. The artifacts can degrade image quality.

### SUMMARY

According to one aspect of the present invention, a sensor image is processed by applying a first demosaicing kernel to produce a sharp image; applying a second demosaicing kernel to produce a smooth image; and using the sharp and smooth images to produce an output image. Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is an illustration of a method of processing a sensor image in accordance with an embodiment of the present invention.

FIG. 2 is an illustration of an apparatus for processing a sensor image in accordance with a first embodiment of the present invention.

FIG. 3 is an illustration of an apparatus for processing a sensor image in accordance with a second embodiment of the present invention.

FIG. 4 is an illustration of an “edge-stop” function.

### DETAILED DESCRIPTION

As shown in the drawings and for purposes of illustration, the present invention is embodied in a digital imaging system. The system includes a sensor array having a single layer of non-overlaying sensors. The sensors may be arranged in plurality of color filter array (CFA) cells. As an example, each CFA cell may include four non-overlaying sensors: a first sensor for detecting red light, a second sensor for detecting blue light, and third and fourth sensors for detecting green light. Such a sensor array has three color planes, with each plane containing sensors for the same color. Since the sensors do not overlap, only a single color is sensed at each pixel.

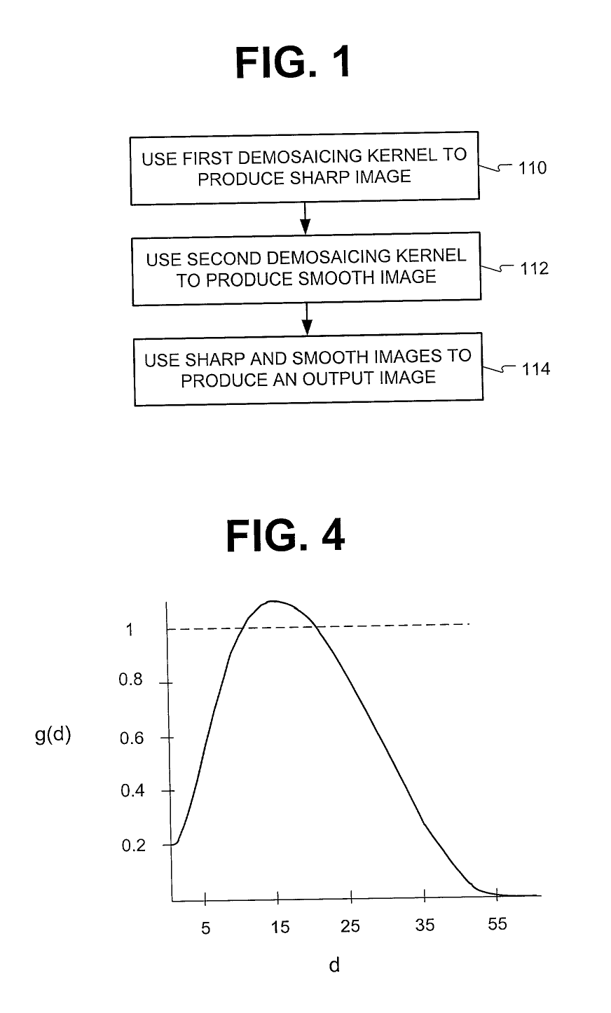

Reference is now made to FIG. 1, which shows a method of processing a sensor image produced by the sensor array. A first demosaicing kernel is applied to the sensor image to produce a fully sampled, sharp image (110). The first demosaicing kernel generates missing color information at each pixel. To generate the missing color information at a particular pixel, information from neighboring pixels may be used if there is a statistical dependency among the pixels in the same region. The first demosaicing kernel is not limited to any particular type of demosaicing algorithm. The demosaicing algorithm may be non-linear, space invariant, or it may be linear-space invariant.

Design of kernels or kernel sets for performing linear translation-invariant demosaicing is disclosed in U.S. Ser. No. 09/177,729 filed Oct. 23, 1998, and incorporated herein by reference. Such a kernel is referred to as a “Generalized Image Demosaicing and Enhancement” (GIDE) kernel. Each GIDE kernel includes one matrix of coefficients for each location within a CFA cell and each output color plane. For a CFA cell having a Bayer pattern, the GIDE kernel has twelve matrices (four different locations times three output color planes). This is also equivalent to four tricolor-kernels. If the kernel is the same for every CFA cell, the kernel is linear space invariant. The kernels could be space variant (i.e., a different set for every CFA mosaic cell). However, linear-space invariant GIDE kernels are less computationally intensive and memory intensive than most non-linear and adaptive kernels.

One of the design parameters for the GIDE kernel is point spread function (PSF). The PSF represents optical blur. Optics of the digital imaging system tend to blur the sensor image. The GIDE kernel uses the PSF to correct for the optical blur and thereby produce a sharp image.

A second demosaicing kernel is applied to the sensor image to produce a smooth image (112). The second demosaicing kernel also generates missing color information at each pixel. The second demosaicing kernel is not limited to any particular type. For instance, a smooth image may be generated by replacing each pixel in the sensor image with a weighted average if its neighbors.

The second demosaicing kernel may be a second GIDE kernel, which does not correct for optical blur. For example, the PSF for the second GIDE kernel may be designed to have a small effective spread support, or it may be replaced with an impulse function. There are certain advantages to using the same GIDE algorithm to produce the sharp and smooth images, as will be discussed below.

In the smooth image, artifacts are almost invisible. In contrast, the sharp image produced by the first GIDE kernel tends to be noisy, and it tends to generate visible artifacts such as color fringes.

The sharp and smooth images are used to produce an output image in which sharpening artifacts are barely visible, if visible at all (114). The output image may be produced as follows. Differences between spatially corresponding pixels of the sharp and smooth images are taken. The difference d(x,y) may be taken as d(x,y)=s(x,y)−b(x,y), where s(x,y) represents the value of the pixel at location [x,y] in the smooth image, and b(x,y) represents the value of the pixel at location [x,y] in the sharp image. The difference includes three components, one for each color plane.

Each difference component for each location is processed. A very large difference is likely to indicate an oversharpening artifact, which should be removed. Thus, the magnitude of the difference would be significantly reduced or clipped. A very small difference is likely to indicate noise that should be reduced or removed. Thus, the magnitude would be reduced to reduce or remove the noise. Differences that are neither very large nor very small are likely to indicate fine edges, which may be preserved or enhanced. Thus, the magnitude would be increased or left unchanged. Actual changes in the magnitudes are application-specific. For example, the processing may depend upon factors such as sensor response and accuracy, ISO speed, illumination, etc.

The processed differences are added back to the smooth image. Thus, a pixel o(x,y) in the output image is represented as o(x,y)=b(x,y)+d′(x,y), where d′(x,y) is the processed difference for the pixel at location [x,y].

The method just described is not limited to any particular hardware implementation. It could be implemented in an ASIC, or it could be implemented in a personal computer. However, GIDE is the result of a linear optimization, which makes it well suited for those digital cameras (and other imaging devices) that support only linear space-invariant demosaicing.

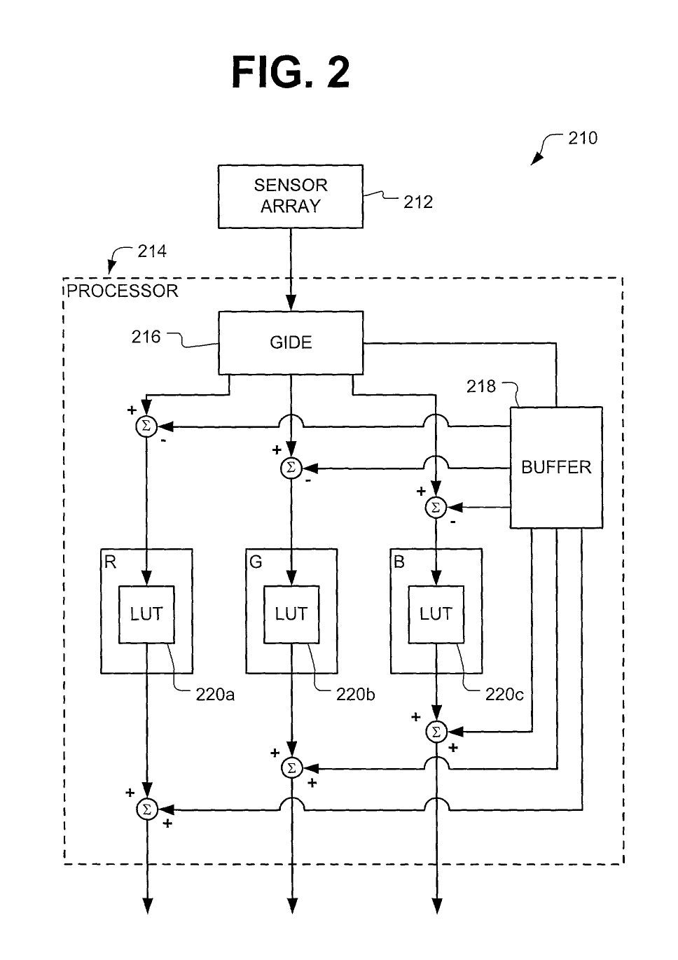

Reference is now made to FIG. 2, which shows an exemplary digital imaging apparatus 210. The apparatus 210 includes a sensor array 212 having a single layer of non-overlaying sensors, and an image processor 214. The image processor 214 includes a single module 216 for performing GIDE operations, and different color channels for the different color planes.

A sensor image is generated by the sensor array 212 and supplied to the GIDE module 216. The GIDE module 216 performs two passes on the sensor image. During the first pass, the GIDE module 216 applies the second GIDE kernel. Resulting is a smooth image, which is stored in a buffer 218. During the second pass, the GIDE module 216 applies the first GIDE kernel, which produces a sharp image.

The GIDE module 216 outputs the sharp image, pixel-by-pixel, to the color channels. Each color channel takes differences, one pixel at a time, between the smooth and sharp images, uses an LUT to process the differences, and adds the differences back to the smooth image. If RGB color space is used, a Red channel takes differences between red components of the smooth and sharp images, uses a first LUT 220a to process the differences, and adds the processed differences to the red plane of the smooth image; a Green channel takes differences between green components of the smooth and sharp images, uses a second LUT 220b to process the differences, and adds the processed differences to the green plane of the smooth image; and a Blue channel takes differences between blue components of the smooth and sharp images, uses a third LUT 220c to process the differences, and adds the processed differences to the blue plane of the smooth image. An output of the image processor 214 provides an output image having full color information at each pixel.

In the embodiment of FIG. 2, different LUTs 220a, 220b and 220c are used for the different color channels. However, the present invention is not so limited. The three LUTs 220a, 220b and 220c may be the same.

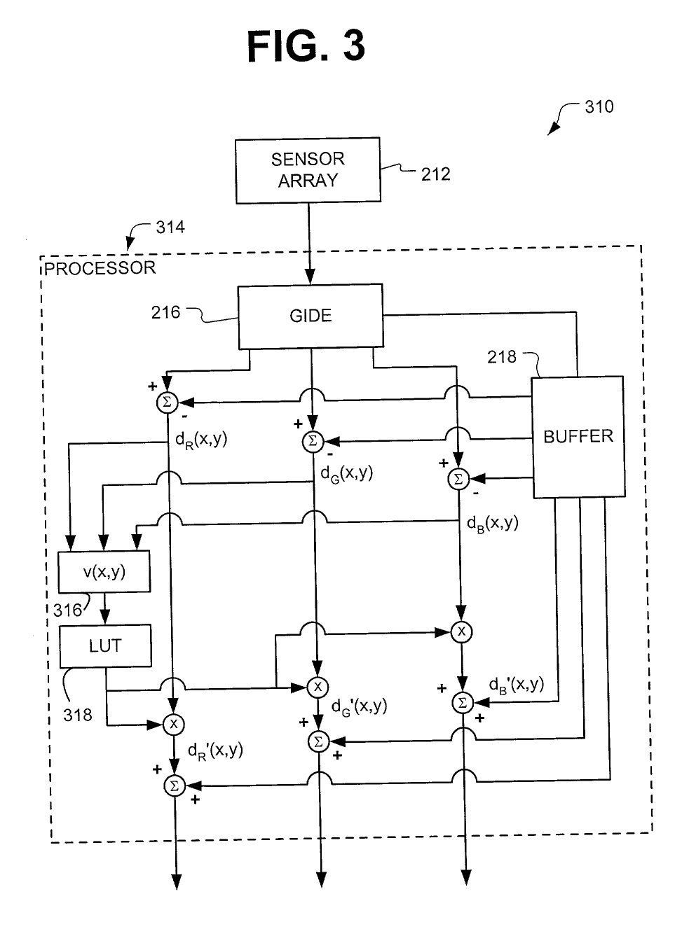

Reference is made to FIG. 3, which shows a system 310 including an image processor 314. The image processor 314 generates difference components. The component d_{R}(x,y) denotes the pixel difference at location [x,y] between the smooth and sharp images in the red plane; the component d_{G}(x,y) denotes the pixel difference at location [x,y] between the smooth and sharp images in the green plane; and the component d_{B}(x,y) denotes the pixel difference at location [x,y] between the smooth and sharp images in the blue plane.

A block 316 of the image processor 314 computes a single value v(x,y) as a function of the difference components d_{R}(x,y), d_{G}(x,y), and d_{B}(x,y). An exemplary function is as follows:

v(x,y)=(a_{R}|d_{R}(x,y)|^{p}+a_{G}|d_{G}(x,y)|^{p}+a_{B}|d_{B}(x,y)|^{p})^{1/p}

where a_{R}, a_{G}, a_{B} and p are pre-defined constants. These constants could be custom designed to a specific camera sensor, assigned as a priori values, etc. As a first example, the a priori values are a_{R}=a_{G}=a_{B}=⅓, and p=1. As a second example, a_{R}, a_{G} and a_{B} have a priori values, and p=∞. Using the values of the second example, the function v(x,y) becomes

v(x,y)=max(a_{R}|d_{R}(x,y)|,a_{G}|d_{G}(x,y)|,a_{B}|d_{B}(x,y)|)

The value v(x,y) is passed through the single LUT 318. Large values representing artifacts are clipped or significantly reduced, small values representing noise are reduced, and intermediate values representing edges are increased. An output of the LUT 318 provides a modified value v′(x,y). The modified value v′(x,y) serves as a common multiplier for each of the components. Thus, d_{R}′(x,y)=v′(x,y)d_{R}(x,y); d_{G}′(x,y)=v′(x,y)d_{G}(x,y); and d_{B}′(x,y)=v′(x,y) d_{B}(x,y).

An edge-stop function g( ) may be used such that v′(x,y)=g[v(x,y)]. The edge-stop function g(·) returns values below one for small and large inputs, whereas it returns values equal to or larger than one for mid-range inputs. This corresponds to reducing noise (small differences) and strong artifacts (large differences), while preserving or enhancing regular edges (mid-range differences).

An edge-stop function may be designed as follows. Let h(z) denote an LUT 318. Set g(z)=h(z)/z, where z is an arbitrary non-zero input value.

An LUT 318 may instead be designed from a edge-stop function such as the edge-stop function shown in FIG. 4. As an example, the LUT 318 can be generated by the equation h(d)=g(d) d.

The modified difference components d_{R}′(x,y), d_{G}′(x,y) and d_{B}′(x,y) are added to the smooth image. An output of the image processor 314 provides an output image having full color information at each pixel.

The present invention is not limited to any particular color space. Possible color spaces other than RGB include, but are not limited to, CIELab, YUV and YcrCb.

The present invention is not limited to the specific embodiments described and illustrated above. Instead, the present invention is construed according to the claims that follow.

1. A method of processing a sensor image, the method comprising:
applying a first demosaicing kernel to the sensor image to produce a sharp image;
applying a second demosaicing kernel to the sensor image to produce a smooth image; and
using the sharp and smooth images to produce an output image.

2. The method of claim 1, wherein the first and second kernels use the same demosaicing algorithm to produce the sharp and smooth sensor images.

3. The method of claim 2, wherein the first and second kernels are designed with different optical blurs to produce the sharp and smooth images.

4. The method of claim 1, wherein the demosaicing kernels use linear-space invariant algorithms.

5. The method of claim 1, wherein the first kernel is a GIDE kernel.

6. The method of claim 1, wherein the second kernel is a GIDE kernel that does not correct for optical blur.

7. The method of claim 1, wherein using the sharp and smooth images includes determining differences between pixels of the sharp and smooth images; and
selectively modifying the differences.

8. The method of claim 7, wherein the selectively modified differences are added to one of the sharp and smooth images.

9. The method of claim 7, wherein large differences indicating artifacts are substantially reduced in magnitude, mid-range differences indicating edges are increased in magnitude or left unchanged, and small differences indicating noise are reduced.

10. The method of claim 7, wherein differences are taken for each color plane, and at least one lookup table is used for different color planes.

11. The method of claim 7, wherein the differences are taken for the color planes, a single correction coefficient is derived from the differences, and the single correction coefficient is used to modify the differences for each of the different color planes.

12. The method of claim 7, wherein an edge-stop function is used to modify the differences.

13. The method of claim 1, wherein the sensor image is obtained by using a sensor including CFA cells having Bayer patterns; and wherein each kernel uses a matrix for each location for each color plane.

14. Apparatus comprising a processor for performing demosaicing operations on a sensor image, the processor generating sharp and smooth images from the sensor image, and using the sharp and smooth images to generate an output image.

15. The apparatus of claim 14, wherein the processor uses the same demosaicing algorithm to produce the sharp and smooth sensor images.

16. The apparatus of claim 15, wherein the processor uses first and second kernels designed with different optical blurs to produce the sharp and smooth images.

17. The apparatus of claim 14, wherein processor uses a linear-space invariant algorithm to produce the sharp image.

18. The apparatus of claim 14, wherein the processor uses a GIDE kernel to produce the sharp image.

19. The apparatus of claim 14, wherein the processor uses a GIDE kernel to produce the smooth image, the GIDE kernel not correcting for optical blur.

20. The apparatus of claim 14, wherein the processor determines the differences between pixels of the sharp and smooth images; and selectively modifies the differences to generate the output image.

21. The apparatus of claim 20, wherein the selectively modified differences are added to one of the sharp and smooth images.

22. The apparatus of claim 20, wherein large differences indicating artifacts are substantially reduced in magnitude, mid-range differences indicating edges are increased in magnitude or left unchanged, and small differences indicating noise are reduced.

23. The apparatus of claim 20, wherein the processor takes differences for each color plane, and uses at least one lookup table to selectively modify the differences for different color planes.

24. The apparatus of claim 20, wherein the processor takes differences for the color planes, derives a single correction coefficient from the differences, and uses the single correction coefficient to selectively modify the differences for each of the different color planes.

25. The apparatus of claim 14, wherein the processor uses an edge-stop function to modify the differences.

26. The apparatus of claim 14, further comprising a sensor array for producing the sensor image, the sensor including CFA cells having Bayer patterns; wherein the demosaicing operations involve using a matrix for each location for each color plane.

27. A digital camera comprising:
a sensor array; and
a processor for performing first and second demosaicing operations on an output of the sensor array, the first demosaicing operation producing a sharp image, the second demosaicing operation producing a smooth image;
the processor using the sharp and smooth images to generate an output image.

28. An article for a processor, the article comprising memory encoded with a program for instructing the processor to perform first and second demosaicing operations on a sensor image, the first demosaicing operation producing a sharp image, the second demosaicing operation producing a smooth image; the program further instructing the processor to use the sharp and smooth images to generate an output image.
